(19) United States
(12) Patent Application Publication
(10) Pub. No.: US 2011/0267819 A1
(43) Pub. Date: Nov. 3, 2011

(54) PORTABLE ELECTRONIC DEVICE HAVING ILLUMINATING MODULE

(75) Inventors: YI-FENG HUANG, Shindian (TW); KAI XU, Shenzhen (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/884,231

(22) Filed: Sep. 17, 2010

(30) Foreign Application Priority Data
Apr. 30, 2010 (CN) 201010160934.3
Jun. 7, 2010 (CN) 201020217063.X

(51) Int. Cl. F21S 4/00

(52) U.S. Cl. 362/249.02; 362/249.01

(57) ABSTRACT

A portable electronic device includes a base, a cover, and an illuminating module. The base includes a printed circuit board. The cover is secured to the base. The illuminating module is secured to the base and is covered by the cover. The illuminating module includes a light strip and a light source. The light source is electrically connected to the printed circuit board and is oriented at one end of the light strip to illuminate the portable electronic device.

### BACKGROUND

1. Technical Field

The disclosure generally relates to portable electronic devices and, particularly, to a portable electronic device including an illuminating module.

2. Description of Related Art

Portable electronic devices are widely used in our daily life. The consumers demand the portable electronic device having good appearance. However, the portable electronic devices are usually adorned by static decorative elements that have a boring appearance after a while.

Therefore, there is room for improvement within the art.

### BRIEF DESCRIPTION OF THE DRAWINGS

Many aspects of the exemplary portable electronic device with an illuminating module can be better understood with reference to the following drawings. The components in the drawings are not necessarily drawn to scale, the emphasis instead being placed upon clearly illustrating the principles of the illuminating module and portable electronic device. Moreover, in the drawings, like reference numerals designate corresponding parts throughout the several views, in which:

FIG. 1 is an assembled, isometric view of a first exemplary embodiment of a portable electronic device with an illuminating module.

FIG. 2 is an exploded view of the portable electronic device of FIG. 1.

FIG. 3 is an enlarged view of one part of the portable electronic device.

FIG. 4 is similar to FIG. 3, but showing the portable electronic device assembled.

FIG. 5 is a cross section view of the portable electronic device taken along line v-v.

FIG. 6 is across section view of a second exemplary embodiment of a portable electronic device.

FIG. 7 is across section view of a third exemplary embodiment of a portable electronic device.

### DETAILED DESCRIPTION

The disclosure is illustrated by way of example and not by way of limitation in the accompanying drawings. It should be noted that references to “an” or “one” exemplary embodiment in this disclosure are not necessarily to the same exemplary embodiment, and such references can include the meaning of “at least one” exemplary embodiment where the context permits.

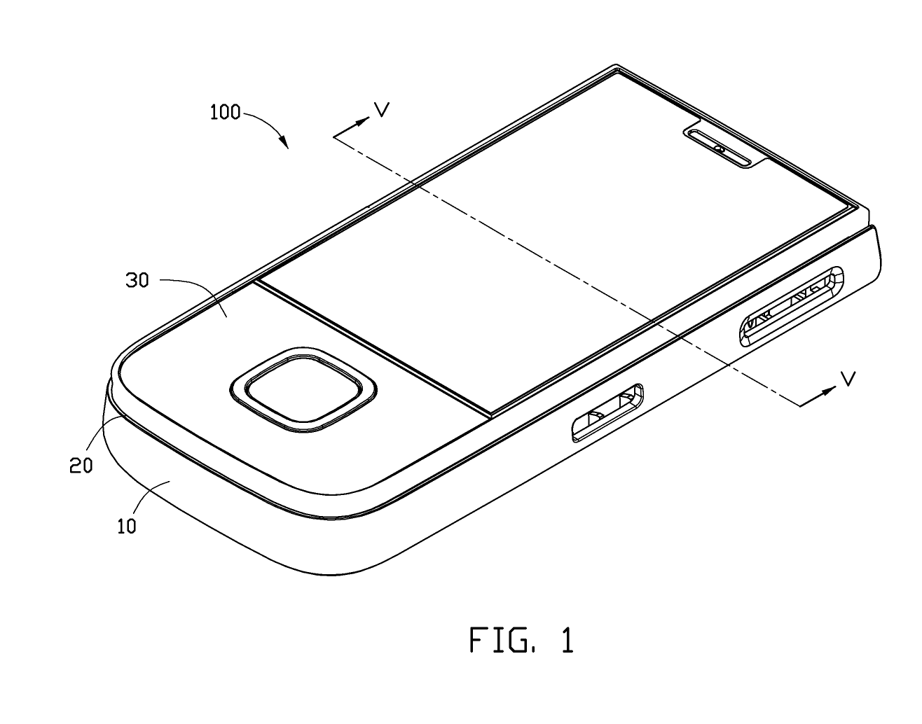

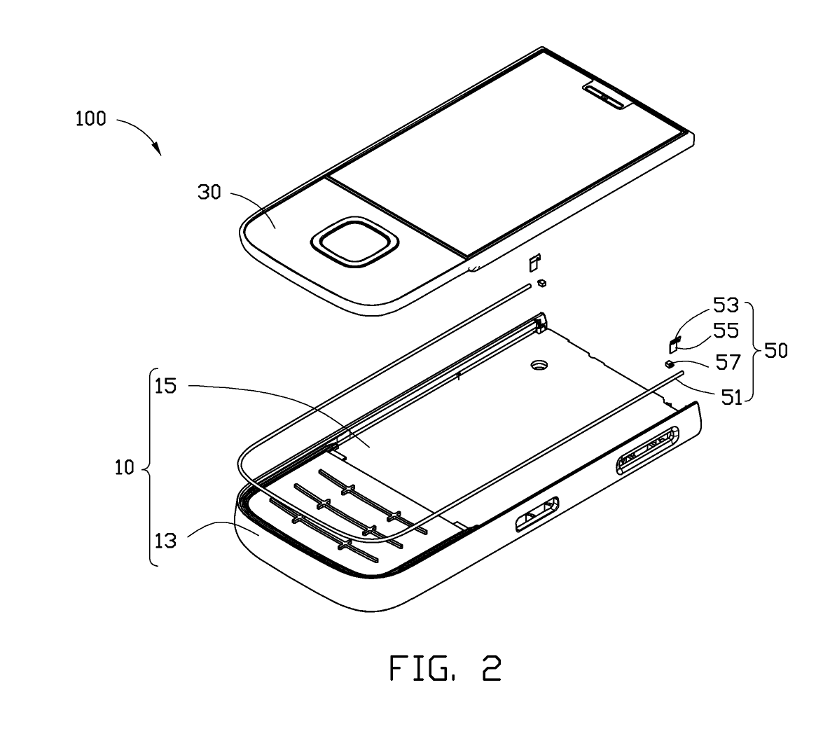

FIGS. 1 and 2 illustrate a first exemplary embodiment of a portable electronic device 100, such as a cellular phone or other electronic devices. The portable electronic device 100 includes a base 10, a cover 30, and an illuminating module 50. Both the base 10 and the cover 30 are made of opaque materials, e.g., metal or opaque plastics. The cover 30 and the illuminating module 50 are fixed to the base 10. A slot 20 is defined between the base 10 and the cover 30, from which the light generated by the illuminating module 50 can pass through. A rib 131 projects from each of two sides of the inner surface of the base 10. A U-shape groove 133 is defined in each of the two sides of the inner surface of the base 10. Each rib 131 is arranged adjacent to one end of the groove 133. A printed circuit board (PCB) 15 is fixed to the base 10 and is electrically connected to the illuminating module 50.

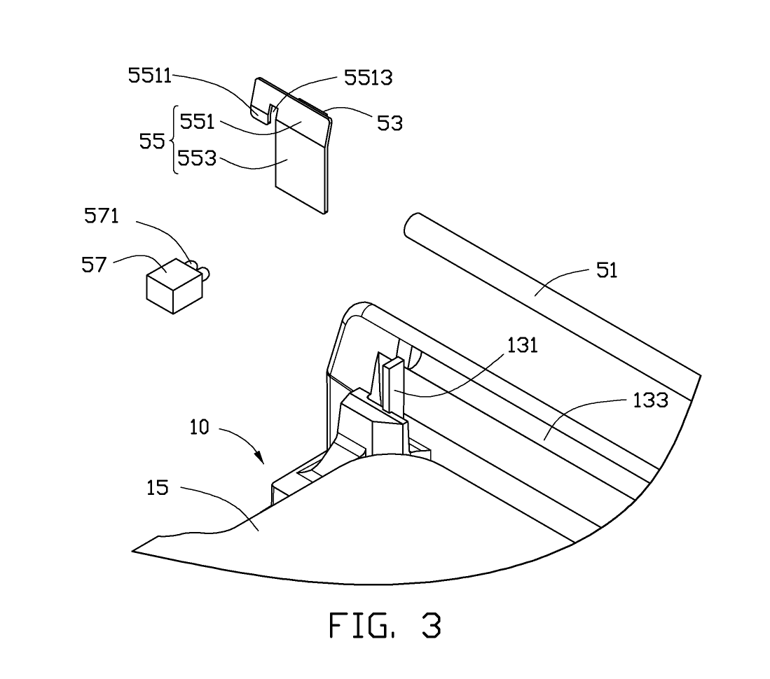

Referring to FIGS. 2 and 3, the illuminating module 50 includes a light strip 51, a light source such as two Light-emitting Diodes (LEDs) 53, two retaining plates 55, and two connectors 57. The light strip 51 is received in the groove 13. Each LED 53 is fixed to each retaining plate 55 and is arranged at each end of the light strip 51 to illuminate the light strip 51. One end of each connector 57 is electrically connected to the PCB 15 and the other end is electrically connected to the retaining plate 55.

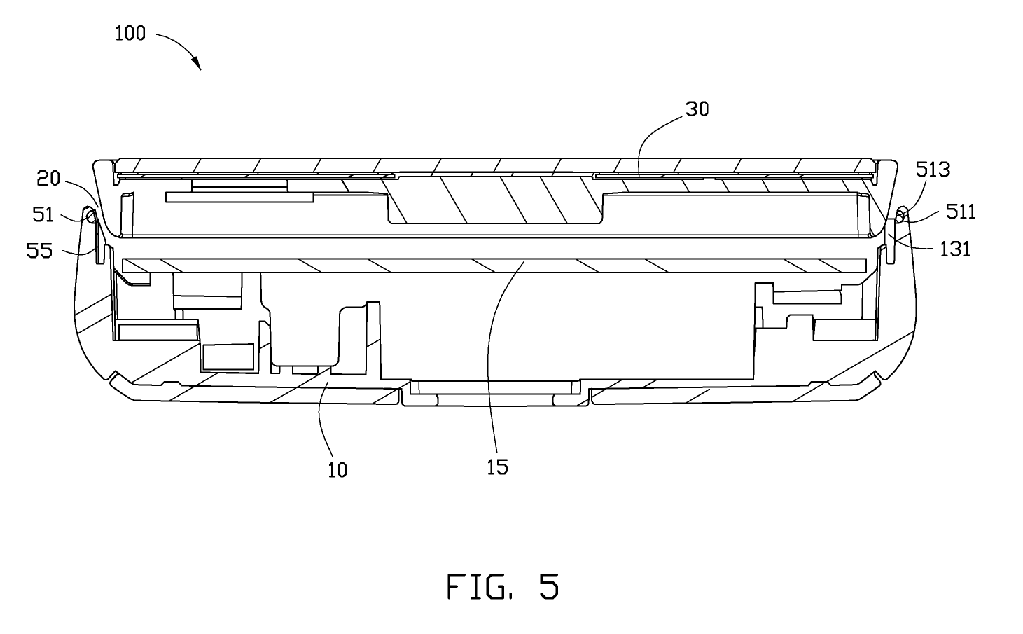

The light strip 51 is made of, e.g., polymethyl methacrylate (PMMA) by injection molding. In one exemplary embodiment, the light strip 51 is co-molded with the base 10 by two-shot injection molding technology. The cross section of the light strip 51 is semicircular (shown in FIG. 5), thus, the light can have high intensity. The LEDs 53 can be organic light-emitting diodes (OLED), or polymer light-emitting diodes (PLED) technologies, or semiconductor light-emitting diodes. The LEDs 53 can generate general light or special-purpose light. Where colored light is required, the LEDs 53 can generate multiple colors.

Each retaining plate 55 is made of conductive materials e.g., metal, and includes a fixing portion 551 and a connecting portion 553 oriented at an angle with respect to the fixing portion 551. The connecting portion 553 is integrally formed with the fixing portion 551 by means of punching. A tab 5511 extends from the fixing portion 551, and a notch 5513 is defined between the tab 5511 and the fixing portion 551. Two protrusions 571 project from one end of each connector 57.

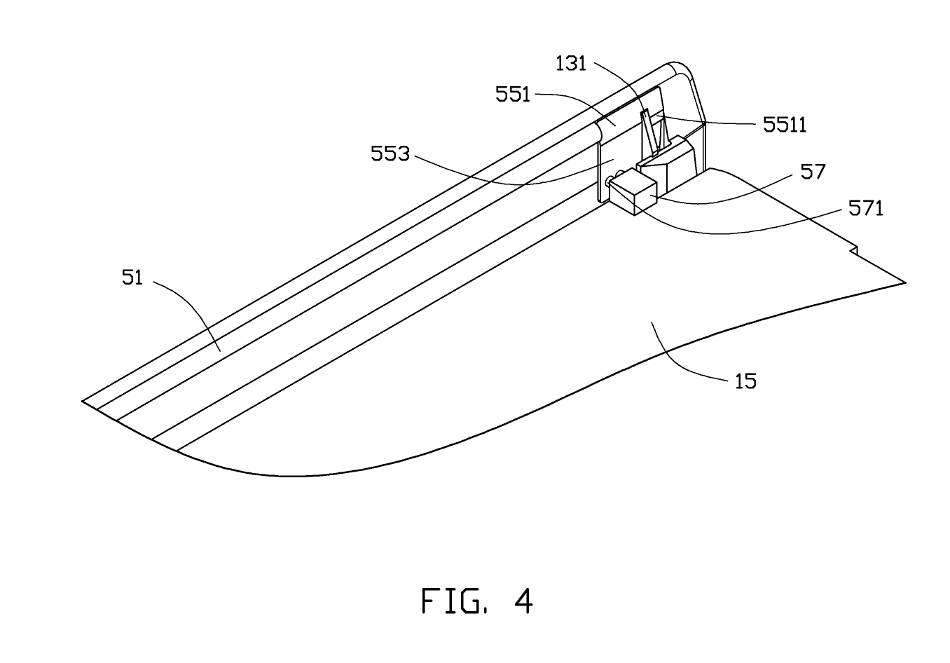

Referring to FIGS. 4 and 5, during assembly, each LED 53 is fixed to the corresponding fixing portion 551 of a corresponding retaining plate 53. Each retaining plate 53 is fixed to the base 10, and each rib 131 is received in a corresponding notch 5513, with the corresponding LED 53 abutting one end of the light strip 51. Then, each connector 57 is fixed to the PCB 15 with the protrusions 571 resisting the corresponding connecting portion 533. Finally, the cover 30 is attached to the base 10. Thus, the portable electronic device 100 is assembled.

When the portable electronic device 100 receives a signal, such as indication of an incoming call, the LEDs 53 are forward biased or switched on by the PCB 15, and the LEDs 53 generate light to illuminate the light strip 51. Thus, the portable electronic device 100 is decorated.

It is to be understood that the light strip 51 and the base 10 can be manufactured separately, and during assembly the light strip 51 is received in the groove 133 and is adhered to the base 10 by one of a number of adhesion means, e.g., glue sticking or fusion.

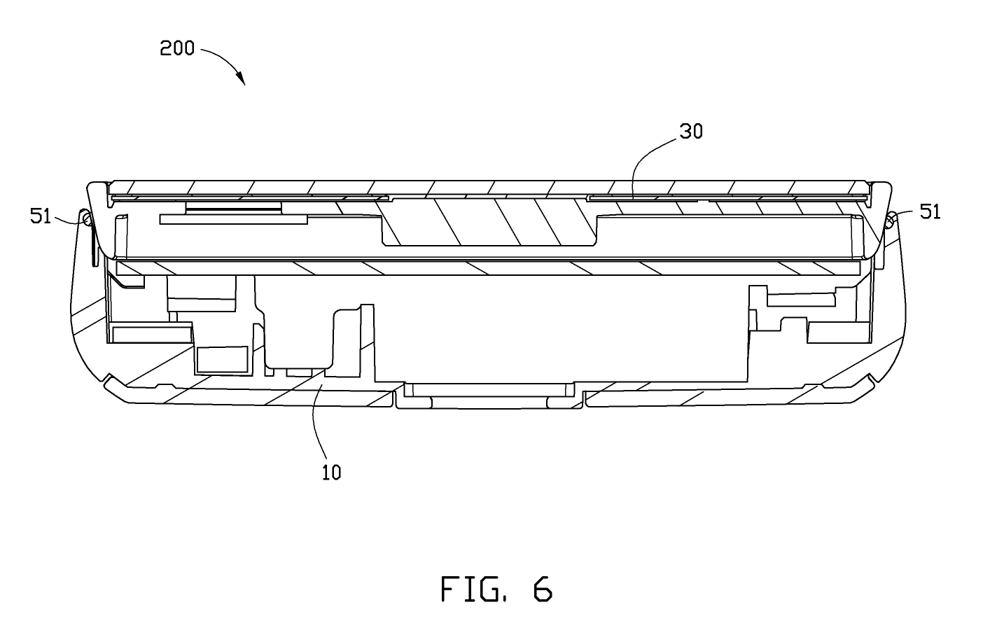

Referring to FIG. 6, in a second exemplary embodiment, a portable electronic device 200 includes a base 10, a cover 30, and a light strip 51. Unlike in the first exemplary embodiment, at least one part of the base 10 or cover 30 adjacent to the light strip 51 is made of transparent materials. The cover 30 is closely attached to the base 10, and the light generated by the LEDs (not shown) can illuminate the transparent part of the base 10 or the cover 30 with the light strip 51.

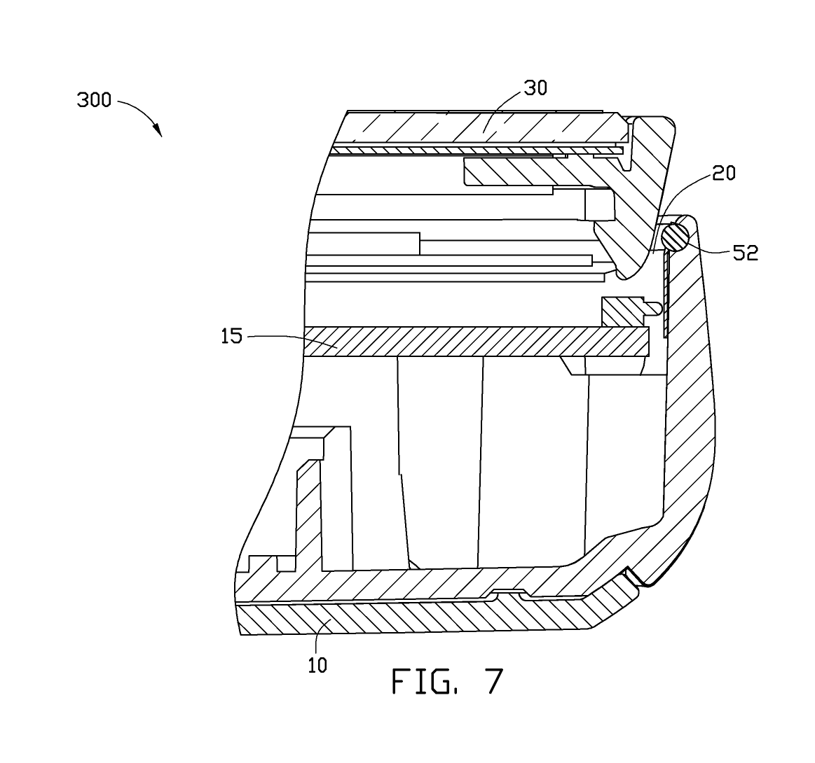

Referring to FIG. 7, in a third exemplary embodiment, a portable electronic device 300 includes a base 10, a cover 30, and a light strip 52. The cross section of the light strip 52 is circular, thus, the light can have soft intensity.

The exemplary embodiments of portable electronic devices include an illuminating module to illuminate the portable electronic device to decorate the portable electronic device or act as a reminder, and the illuminating module is covered and protected by both the base and the cover, thus, the illuminating module can remain reliable for a long period.

It is believed that the present exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A portable electronic device comprising:
a base including a printed circuit board;
a cover secured to the base; and
a illuminating module secured to the base and being covered by the cover, the illuminating module including a light strip and a light source, the light source being electrically connected to the printed circuit board and being oriented at one end of the light strip to illuminate the portable electronic device.

2. The portable electronic device as claimed of claim 1, wherein the light source comprises at least one LED.

3. The portable electronic device as claimed of claim 2, wherein the illuminating module further includes a connector and a retaining plate, the LED is secured to the retaining plate, the retaining plate is electrically connected to the printed circuit board by the connector.

4. The portable electronic device as claimed of claim 3, wherein the retaining plate includes a fixing portion and a connecting portion, the fixing portion oriented at an angle with respect to the connecting portion, the LED fixed to the fixing portion, and the connector resists the connecting portion.

5. The portable electronic device as claimed of claim 4, wherein a rib projects from the base, a tab extends from the fixing portion, a notch is defined between the tab and the fixing portion, which the rib is received in the notch.

6. The portable electronic device as claimed of claim 2, wherein the light strip is made of polymethyl methacrylate and co-molded with the base by two shot injection molding.

7. The portable electronic device as claimed of claim 2, wherein the cross section of the light strip is semicircular.

8. The portable electronic device as claimed of claim 2, wherein the cross section of the light strip is circular.

9. The portable electronic device as claimed of claim 2, wherein the LED is organic LED, or polymer LED, or semiconductor LED.

10. The portable electronic device as claimed of claim 2, wherein both the cover and the base are made of opaque materials, a slot is defined between the base and the cover, from which the light generated by the LED and transferred by the light strip can be emitted.

11. The portable electronic device as claimed of claim 2, wherein at least part of the base or the cover is made of transparent materials, through which the light generated by the LED is transferred by the light strip to an outside of the portable electronic device.

12. A portable electronic device comprising:
a base including a printed circuit board;
a cover secured to the base;
a light strip fixed to the base; and
a light source, the light source being electrically connected to the printed circuit board and illuminating the portable electronic device by the light strip.

13. The portable electronic device as claimed of claim 12, wherein the light source comprises at least one LED.

14. The portable electronic device as claimed of claim 13, wherein further including a connector and a retaining plate, the LED being secured to the retaining plate, the retaining plate being electrically connected to the printed circuit board by the connector.

15. The portable electronic device as claimed of claim 14, wherein the retaining plate includes a fixing portion and a connecting portion, the fixing portion oriented at an angle with respect to the connecting portion, the LED fixed to the fixing portion, the connector electrically resists the connecting portion.

16. The portable electronic device as claimed of claim 14, wherein a rib project from the base, a tab extends from the fixing portion, a notch is defined between the tab and the fixing portion, in which the rib is received.

17. The portable electronic device as claimed of claim 13, wherein the cross section of the light strip is semicircular.

18. The portable electronic device as claimed of claim 13, wherein the cross section of the light strip is circular.

19. The portable electronic device as claimed of claim 13, wherein both the cover and the base are made of opaque materials, a slot is defined between the base and the cover, from which the light generated by the LED and transferred by the light strip can be emitted.

20. The portable electronic device as claimed of claim 13, wherein at least part of the base or the cover is made of transparent materials, through which the light generated by the LED and transferred by the light strip can be emitted.
